(19) United States
(12) Patent Application Publication
(10) Pub. No.: US 2024/0034221 A1
(43) Pub. Date: Feb. 1, 2024

(54) LIGHT ASSEMBLY FOR PERFORMING LIGHTING FUNCTIONS WITH SWITCHING UNITS IN LOW SIDE POSITION

(71) Applicant: FOSHAN ICHIKOH VALEO AUTO LIGHTING SYSTEMS CO., LTD., Foshan, Guangdong (CN)

(72) Inventor: Rujiu OU, Foshan (CN)

(73) Assignee: VALEO VISION, Bobigny (FR)

(21) Appl. No.: 18/258,407

(22) PCT Filed: Dec. 21, 2020
(86) PCT No.: PCT/CN2020/138074

§ 371 Date: Jun. 20, 2023

(51) Int. Cl. B60Q 1/14; H05B 45/44; H05B 45/325

(52) U.S. Cl. CPC B60Q 1/1407; H05B 45/44; H05B 45/325

(57) ABSTRACT

A light assembly including a first lighting module for performing a low beam function, and a second lighting module for performing a high beam function and a driver. The light assembly includes a first switching unit connected in series with the first and second lighting modules and controlled by a first control unit, and a second switching unit connected in parallel to the second lighting module and controlled by a second control unit. The first switching unit is connected in low side position between the second lighting module and the ground.

The present invention concerns the technical field of lighting. It concerns in particular, while not exclusively, a light assembly comprising lighting modules in a headlamp such as a vehicle headlamp.

It is advantageous in the case where several lighting functions are to be performed by a single light assembly.

The Japanese patent JP5396134B2 discloses a light assembly for a vehicle comprising a DC/DC driver and three lighting functions including high beam HB, low beam LB and daytime running light DRL, using respective modules. A switch in parallel to the HB module is used to turn off the HB function. However, the HB function cannot be deactivated without deactivating the LB function when a fail status of the switch mounted in parallel to the HB module occurs (blocked in an open-circuit position for instance), which raises major safety issues, notably because it is generally considered that in a fail-safe mode, only LB function should be activated.

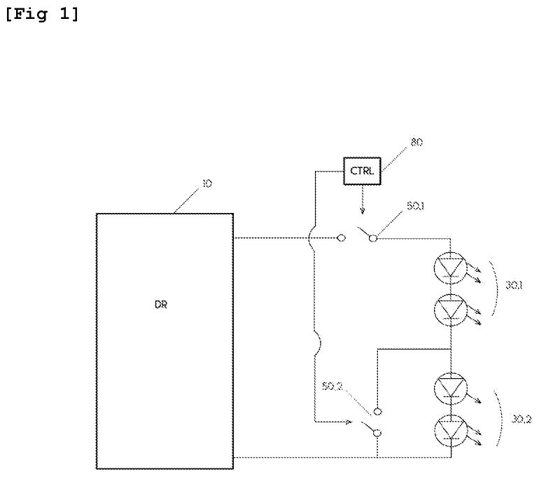

FIG. 1 is a simplified version of FIG. 4 of the above mentioned Japanese patent.

FIG. 1 shows a light assembly 1 comprising a DC/DC driver 10, a low beam lighting module 30.1 and a high beam lighting module 30.2 connected in series. A first switch 50.1 is connected in high side position, i.e. between the driver and the low beam lighting module 30.1, and a second switch 50.2 connected in parallel to the high beam lighting function 30.2.

If the first switch is an N-MOS, a complex additional circuit 80 is required to provide a voltage Vgs between the gate pin and the source pin, because the source pin is not connected to the ground, the first switch being in high side position.

If the first switch is a P-MOS, a complex circuit 80 is also required to provide a voltage Vsg between the source pin and the gate pin.

Therefore, the first switch according to the prior art requires a complex additional circuit to control the opening and closing of the switch controlling the HB and LB functions.

The present invention improves the situation.

To this end, a first aspect of the invention concerns a light assembly comprising:
a first lighting module configured to perform a low beam function;
a second lighting module configured to perform a high beam function;
a driver connected in series with the first lighting module and the second lighting module;
a first switching unit connected in series with the first and second lighting modules;
a second switching unit connected in parallel to the second lighting module;
a first control unit configured to control the first switching unit and a second control unit configured to control the second switching unit.

The first switching unit is connected in low side position between the second lighting module and the ground.

This enables to control the opening and closing of the first switching unit with a simplified first control unit compared to the solution of the prior art where the switch is in high side position.

According to some embodiments, the driver may be configured to provide a fixed power output and the first control unit may be configured to control the first switching unit using Pulse Width Modulation, PWM, to vary the power provided to the first lighting module and/or to the second lighting module.

This allows to adapt the power to the functions and to external conditions, such as brightness for example, without modifying the driver, which can provide a fixed power output. Alternatively, the first switching unit is open and the second switching unit is controlled using PWM to vary the power provided to the first lighting module. Still alternatively, both the first switching unit and the second switching units are controlled using PWM to vary the power provided to both the first lighting module and to the second lighting module.

According to some embodiments, the light assembly may further comprise a high beam measuring unit connected in parallel to the second lighting module, a third switching unit connected in series with the high beam measuring unit and a third control unit configured to control the third switching unit. The third control unit may be configured to open the third switching unit when the first switching unit is open.

This enables to avoid the LB function to be slightly ignited when both the first and second switching units are open.

According to some embodiments, the light assembly may further comprise a fourth switching unit in series between the first lighting module and the second lighting module, and a fourth controller configured to control the fourth switching unit. The fourth controller may be configured to open the fourth switching unit upon detection that a minus terminal of the second lighting module is short circuited to the ground.

This allows to prevent a situation where the HB function is activated although the second switching unit is open, which would otherwise raise major safety issues.

According to some embodiments, the light assembly may further comprise a third lighting module connected in parallel to the first lighting module, the second lighting module and the first switching unit. The third lighting module may be configured to perform a third lighting function.

This allows performing at least three lighting functions using the same driver, which reduces the costs of the light assembly.

In complement, the third lighting function may be a position lighting function and/or a daytime signaling function. Alternatively, the third lighting module may be configured to perform a Turn Indicator, TI function, a fog lighting function, or any other lighting/signaling function. Alternatively or in complement, the light assembly may comprise a fifth switching unit in series with the third lighting module.

This allows to activate/deactivate the third lighting function, thereby reducing the power consumption of the light assembly.

In complement, the fifth switching unit may be in high side position, between a plus terminal of the third lighting module and the driver.

Compared to the low side position, this avoids having the third lighting module turned on when it is short circuited to the ground.

Alternatively, the fifth switching unit may be in low side position, between a minus terminal of the third lighting module and the ground.

This allows to simplify the control unit used to control the fifth switching unit.

According to some embodiments, the driver may be configured to output a fixed power output and the fifth control unit may be configured to control the fifth switching unit using Pulse Width Modulation to vary the power applied to the third lighting module.

This allows to control several functions using a single and simple driver.

According to some embodiments, the first switching unit and the second switching unit may be controlled by a common control unit.

This allows simplifying the control of the first and second switching units, thereby reducing the costs of the light assembly.

According to some embodiments, the first switching unit and/or the second switching unit may be an N-MOS.

Therefore, the source of the N-MOS is directly connected to the ground and the N-MOS can be controlled by a simple circuitry.

In complement, both the first switching unit and the second switching unit may be N-MOS. This allows mutualizing a simple circuitry between the first and second switching units.

Other features and advantages of the invention are made explicit from the description detailed hereafter, and from the attached drawings, on which:

FIG. 1 shows a light assembly according to the prior art;

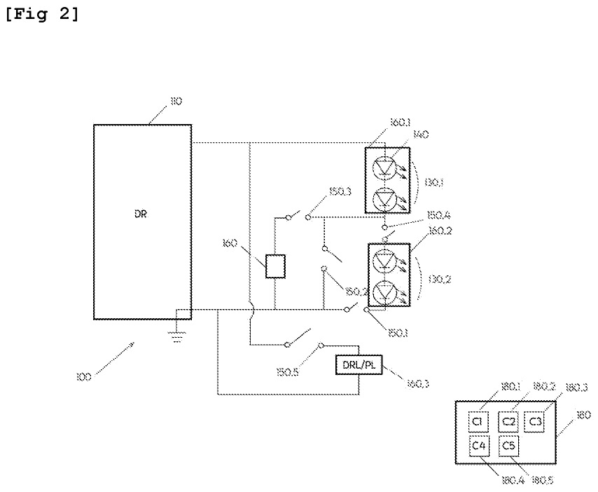

FIG. 2 shows a light assembly, according to some embodiments of the invention.

FIG. 2 illustrates a light assembly 100 according to some embodiments of the invention. The light assembly comprises a driver 110.

The driver can be connected to a power source that is not represented on FIG. 1. The power source 120 may be a voltage source or a current source according to the invention. In what follows, the example of a voltage source is considered, for illustrative purposes only.

The power source may be a DC voltage source and the driver 110 may be a DC/DC driver. Alternatively, the power source is an AC voltage source and the driver 110 is an AC/DC driver.

The light assembly 100 according to the invention further comprises a first lighting module 130.1 arranged for performing a low beam function and a second lighting module 130.2 arranged for performing a high beam function. LB and HB functions are complementary functions and the HB function is additional to the LB function: this means that the HB function can only be activated while the LB is turned on. However, the LB function can be turned on while the HB function is turned off.

The first lighting module 160.1 and the second lighting module 160.2 may be integrated in a headlamp, such as a vehicle headlamp for example.

The first lighting module 160.1 may comprise a first series 130.1 of lighting units 140 and the second lighting module 160.2 may comprise a second series 130.2 of lighting units 140. The lighting units 140 can be any technology able to emit light when a voltage is applied to it. In what follows, the example of lighting units being diodes such as LEDs is considered, for illustrative purposes only. The wording «LED» is therefore used to replace «lighting unit» in what follows, without departing from the fact that the lighting unit can encompass other technologies than LED.

No restriction is attached to the number of LEDs 140 per function. In the example shown on FIG. 1, the LB and HB functions are implemented by respective series 130.1 and 130.2 of two LEDs 140. However, according to the invention, the LB and HB functions can be implemented by any numbers n1 and n2 of LEDs 140, n1 and n2 being integers equal to or greater than 1.

So as to selectively activate/deactivate the LB and HB functions, the light assembly 100 may further comprise a first switching unit 150.1 and a second switching unit 150.2.

The first switching unit 150.1 is connected in series with the first lighting module 130.1 and the second lighting module 130.2. However, contrary to the prior art, the first lighting module is in low side position, so that one of its terminals is directly connected to the ground. This allows to more easily control the first switching unit 150.1, in particular when the first switching unit 150.1 is an N-MOS. No restriction is attached to the technologies used for the switching units, which can for example be any transistor configured to perform a switching function.

The second switching unit 150.2 is connected in parallel to the second lighting module 130.2.

As a terminal of the first switching unit 150.1 and a terminal of the second switching unit 150.2 are directly connected to the ground, it is easier to control their opening and closing compared to the prior art.

The first and second switching units 150.1 and 150.2 can be controlled by control units 180.1 and 180.2 of a controller 180. No restriction is attached to such control units, which can be a microprocessor or a command circuitry arranged for processing command signals to control the switching units 150.1 and 150.2 accordingly. The control unit 180 can be integrated in the driver 110.

Advantageously, when both the first and second switching units 150.1 and 150.2 are N-MOS, they can be controlled by the same control unit. The control units 180.1 and 180.2 are one and the same unit.

The light assembly 100 according to FIG. 1 allows to control the HB and LB functions as complementary functions, where the HB function can be activated in addition to the LB function, and where the LB function can be activated without the HB function. Indeed:
to activate the LB function only, the first switching unit 150.1 and the second switching unit 150.2 are closed;
to activate both the LB and HB functions, the first switching unit 150.1 is closed and the second switching unit 150.2 is open;
to deactivate both the LB and HB functions, the first switching unit 150.1 and the second switching unit 150.2 are open.

The driver 110 can adapt the power output to the activated function(s) and can be synchronized with the first and second switching units 150.1 and 150.2. Alternatively, the power output by the driver 110 is fixed and the power provided to the lighting modules is varied by controlling the first switching unit 150.1 using Pulse Width Modulation, PWM.

According to other alternatives:
the first switching unit 150.1 is open and the second switching unit 150.2 is controlled using PWM, which allows dimming the LB function only;
the first switching unit 150.1 is closed and the second switching unit 150.2 is controlled using PWM, which allows dimming both the HB and LB functions;
the first switching unit 150.1 and the second switching unit 150.2 are both controlled using PWM, which allows dimming both the HB and LB functions.

The light assembly 100 may further comprise a HB measuring unit 160 that can be assimilated to a resistor as shown on FIG. 2, in parallel to the second lighting module 130.2. In that case, when both first and second switching units are open, to deactivate both LB and HB functions, a current running through the resistor 160 may slightly ignite the first lighting module 130.1, although the LB function is deactivated.

To avoid this, the light assembly 100 may further comprise a third switching unit 150.3 in series with the HB measuring unit 160. The third switching unit 150.3 may be controlled by a third control unit 180.3.

The third switching unit 150.3 is advantageously open when the HB lighting function is deactivated, as there is no need to measure the second lighting module 130.2 in that situation. The third switching unit 150.3 is therefore controlled in the same manner as the first switching unit 150.1:
the third switching unit 150.3 is closed when the first switching unit 150.1 is closed;
the third switching unit 150.3 is opened when the first switching unit 150.1 is opened.

Therefore, the first and third control units 180.1 and 180.3 can be one and the same control unit.

A problem may arise when the negative terminal of the second lighting module 130.2 is short circuited to the ground. Indeed, control of the lighting functions using the first switching unit 150.1 and the second switching unit 150.2 is lost, so that both the LB and HB functions are activated. This raises security issues as the high beam function cannot be deactivated using the second switch, as the current flows from the driver to the ground via first lighting module 130.1 and the second lighting module 130.2 without going through any switching unit. To solve this problem, the light assembly 100 may further comprise a fourth switching unit 150.4 connected in series between the first lighting module 130.1 and the second lighting module 130.2 and in parallel with the second switching unit 150.2.

The fourth switching unit 150.4 may be controlled by a fourth control unit 180.4.

In addition to the two lighting functions described above, the light assembly 100 may be arranged to implement at least a third function. To this end, the light assembly 100 may comprise a third lighting module 160.3, which may comprise a third series of LEDs, not represented on FIG. 2. The third lighting function may be powered by the output voltage of the driver 110 also used for the other functions.

Alternatively, a second driver of light assembly may be dedicated to the third lighting function. This alternative is not shown on FIG. 2.

The third lighting function can be a Daytime Running Light, DRL, function. Alternatively, the third lighting function can be a Position Lighting PL function.

According to another embodiment, both DRL and PL functions can be performed by the third lighting module 160.3. This allows to perform several functions without adding new components to the light assembly 100.

Activation and deactivation of the third lighting module 160.3 can be performed via a fifth switching unit 150.5, connected in series with the third lighting module 160.3. For example, the fifth switching unit 150.5 can be in high side position, located between the first driver 110.1 and the additional output pin 190.6 connected to the plus terminal of the third lighting module 160.3. Alternatively, the fifth switching unit 150.5 can be in low side position, mounted between the minus terminal of the third lighting module 130.3 and the ground, which allows controlling the fifth switching unit 150.5 in a simple manner. The fifth switching unit 150.5 can be controlled by an external control unit that is not shown on FIG. 2.

In the alternative where a second driver of light assembly is dedicated to the third lighting function, the fifth switching unit 150.5 is optional as activation/deactivation of the third lighting function can be controlled by the second driver directly, via an enable signal for example.

The driver 110 may be able to vary the output voltage depending on the function to be performed by the third lighting module 130.3, such as DRL or PL. Alternatively, the output voltage of the driver 110 is fixed and the voltage applied to the third lighting module 130.3 can be varied controlling the fifth switching unit 150.5 using Pulse Width Modulation, PWM. The fifth switching unit 150.5 may be controlled by a fifth control unit 180.5.

For example, a first voltage value can be applied to the third lighting module 130.3 for the PL function while a second voltage value may be applied for the DRL function. The first voltage value may be less than the second voltage value, which allows to avoid glaring other drivers at night time, and to ensure that the vehicle is visible at day time. This improves the security associated with the lighting functions and also optimizes the power consumption of the light assembly 100.

The first driver 110.1 may power more than three functions, for example by using additional outputs of the first driver 110.1 and adding other additional pins to the driver block 110.

In any of the embodiments described above, the drivers 110 may encompass any technology that is able to convert a power input into a power output different from the power input. The power input and power output may differ by their type (DC or AC) and/or by their values (two DC powers having different values). The drivers can for example be electronic circuitries, such as Single Ended Primary Inductor Converters, SEPICs. However, no restriction is attached to the circuitry used as the drivers 110 which can encompass other examples, such as buck converters, boost converters and/or buck-boost converters.

The present invention is not limited to the embodiments described above as examples: it extends to other alternatives.

1. A light assembly comprising:
a first lighting module configured to perform a low beam function;
a second lighting module configured to perform a high beam function;
a driver connected in series with the first lighting module and the second lighting module;
a first switching unit connected in series with the first and second lighting modules;
a second switching unit connected in parallel to the second lighting module;
a first control unit configured to control the first switching unit and a second control unit configured to control the second switching unit;
wherein:
the first switching unit is connected in low side position between the second lighting module and the ground.

2. The assembly according to claim 1, wherein the driver is configured to provide a fixed power output and wherein the first control unit is configured to control the first switching unit using Pulse Width Modulation, PWM, to vary the power provided to the first lighting module and/or to the second lighting module.

3. The assembly according to claim 1, further comprising a high beam measuring unit connected in parallel to the second lighting module, a third switching unit connected in series with the high beam measuring unit and a third control unit configured to control the third switching unit, wherein the third control unit is configured to open the third switching unit when the first switching unit is open.

4. The assembly according to claim 1, further comprising a fourth switching unit in series between the first lighting module and the second lighting module, and a fourth controller configured to control the fourth switching unit,
wherein the fourth controller is configured to open the fourth switching unit upon detection that a minus terminal of the second lighting module is short circuited to the ground.

5. The assembly according to claim 1, further comprising a third lighting module connected in parallel to the first lighting module, the second lighting module and the first switching unit, wherein the third lighting module is configured to perform a third lighting function.

6. The assembly according to claim 5, wherein the third lighting function is a position lighting function and/or a daytime signaling function.

7. The assembly according to claim 5, further comprising a fifth switching unit in series with the third lighting module.

8. The assembly according to claim 7, wherein the fifth switching unit is in high side position, between a plus terminal of the third lighting module and the driver.

9. The assembly according to claim 7, wherein the fifth switching unit is in low side position, between a minus terminal of the third lighting module and the ground.

10. The assembly according to claim 7, wherein the driver is configured to provide a fixed power output and wherein the fifth control unit is configured to control the fifth switching unit using Pulse Width Modulation to vary the power provided to the third lighting module.

11. The assembly according to claim 1, wherein the first switching unit and the second switching unit are controlled by a common control unit.

12. The assembly according to claim 1, wherein the first switching unit and/or the second switching unit is an N-MOS.

13. The assembly according to claim 11, wherein the first switching unit and the second switching unit are N-MOS.

14. The assembly according to claim 2, further comprising a fourth switching unit in series between the first lighting module and the second lighting module, and a fourth controller configured to control the fourth switching unit,
wherein the fourth controller is configured to open the fourth switching unit upon detection that a minus terminal of the second lighting module is short circuited to the ground.

15. The assembly according to claim 2, further comprising a third lighting module connected in parallel to the first lighting module, the second lighting module and the first switching unit, wherein the third lighting module is configured to perform a third lighting function.

16. The assembly according to claim 6, further comprising a fifth switching unit in series with the third lighting module.

17. The assembly according to claim 8, wherein the driver is configured to provide a fixed power output and wherein the fifth control unit is configured to control the fifth switching unit using Pulse Width Modulation to vary the power provided to the third lighting module.

18. The assembly according to claim 2, wherein the first switching unit and the second switching unit are controlled by a common control unit.

19. The assembly according to claim 2, wherein the first switching unit and/or the second switching unit is an N-MOS.

20. The assembly according to claim 12, wherein the first switching unit and the second switching unit are N-MOS.
